(19) United States
(12) Patent Application Publication
(10) Pub. No.: US 2019/0226608 A1
(43) Pub. Date: Jul. 25, 2019

(54) CONDUIT ANCHOR CLAMP

(71) Applicant: The Metraflex Company, Chicago, IL (US)

(72) Inventor: James R. Richter, Chicago, IL (US)

(21) Appl. No.: 16/253,002

(22) Filed: Jan. 21, 2019

Related U.S. Application Data
(60) Provisional application No. 62/621,410, filed on Jan. 24, 2018.

(51) Int. Cl. F16L 5/00; F16L 3/10; H02G 3/22

(52) U.S. Cl. CPC F16L 5/00; H02G 3/22; F16L 3/1091

(57) ABSTRACT

An anchor for a conduit. The conduit extends through a barrier. The anchor has a body formed from two or more members. An aperture extends through the body and surrounds the conduit. The members of the body are held together with one or more fasteners. A plurality of teeth within the body extend into the aperture and engage the outer surface of the conduit to secure a purchase of the conduit and hold it in position relative to the barrier.

### RELATED APPLICATIONS

The present application claims priority to U.S. Ser. No. 62/621,410 filed on Jan. 24, 2018, the entirety of which is incorporated herein by reference.

### BACKGROUND OF THE INVENTION

The present invention relates to a conduit, and more particularly to a clamp for a conduit.

In the construction of buildings and other structures, it is known to use conduits that extend vertically through floors or other horizontal barriers. In order to restrict the movement of the conduit, an anchor may be utilized to maintain the position of the conduit.

For example, U.S. Pat. Nos. 4,488,388 and 9,982,803 and U.S. Pat. Pub. No. 2013/0213546 disclose such anchors that are utilized with conduits passing through barriers, like a wall, floor, or ceiling.

While presumably effective for their intended purposes, there is an ongoing desire to provide an anchor that is easily installed and removed.

### SUMMARY OF THE INVENTION

A new anchor for a conduit that passes through a barrier has been invented.

The anchor provides a way to both clamp a riser and anchor a pipe from any movement. The anchor includes a plurality of gripping teeth that securely bite into the pipe. The anchor is adjustable, requires no welding, and allows access for installing fire-stopping material. Additionally, the present anchor has a body formed from multiple parts. The allow the present anchor to be installed more quickly compared to those that must be installed at an end of the conduit. Additionally, this configuration allows for the present conduit to be installed on existing conduits—without cutting or otherwise adjusting the conduit.

In use, one anchor may be installed on either side of the floor as a riser anchor clamp. The teeth engage the surface of the conduit to maintain the position of the conduit relative to the floor. However, by using two anchors, one on each side of the floor, the conduit may be more securely held in position with respect to the floor. The anchor(s) are removable, allowing the anchor(s) or conduit to be adjusted.

Accordingly, in a first aspect of the present invention, the present invention may be generally characterized as providing an anchor for a conduit, in which the conduit extends through a barrier, and where the anchor includes: a body having a plurality of body members, the body members forming an aperture for the conduit; at least one fastener holding the body members together; and, teeth extending into the aperture. The aperture may include an inner surface facing the conduit and the teeth may extend inwardly from the inner surface. The body may include at least one slot, and the teeth may be received in the slot. The teeth may have a shape that, when viewed from a top, is concentric with the aperture. The teeth may be formed from a plurality of alternating peaks and valleys. The anchor may include a plurality of teeth disposed equidistantly, relative to each other, around a circumference of the aperture. The body members may include complementarily configured engaging structures configured to ensure alignment of adjacent body members. The teeth may be made from a material that is harder than a material of the conduit. The body may be formed from two body members, and each body member may include two slots, and the anchor may include four pluralities of teeth extending into the aperture such that each slot includes a plurality of teeth. The teeth may be each formed from a plurality of alternating peaks and valleys.

In a second aspect of the present invention, the present invention may be broadly characterized as providing an anchor for a conduit extending through a barrier. The anchor includes a body having a plurality of body members. The body members may form a cylindrical aperture for the conduit. Each body member may include a slot. Teeth may be slideably received within each of the slots. The teeth may extend inwardly toward a center of the cylindrical aperture. The teeth may be movable independent of each other. The teeth may be formed from a plurality of alternating peaks and valleys. The anchor may include a plurality of teeth disposed equidistantly, relative to each other, around a circumference of the aperture. The body members may include complementarily configured engaging structures configured to ensure alignment of adjacent body members. The teeth may be made from a material that is harder than a material of the conduit.

In a third aspect of the present invention, the present invention may be characterized as providing a method of supporting a conduit passing through a barrier by: positioning each of a plurality of body members around the conduit, wherein the conduit passes through the barrier; tightening at least one fastener to secure together the body members; and, deforming an outer surface of the conduit by teeth in the body members to engage the conduit. The body members may be positioned on an upper surface of the barrier. The method may also include: positioning each of a second plurality of body members around the conduit on a lower surface of the barrier; tightening at least one fastener to secure together the body members from the second plurality of body members; and, deforming the outer surface of the conduit by teeth in the body members from the plurality of body members. The method may include slideably inserting the teeth into each of the body members prior to positioning the body members around the conduit.

These and other aspects and embodiments of the present invention will be appreciated by those of ordinary skill in the art based upon the following description of the drawings and detailed description of the preferred embodiments.

### BRIEF DESCRIPTION OF THE DRAWINGS

The attached figures in the drawings will make it possible to understand how the invention can be produced. In these figures, similar reference numbers denote similar elements.

FIG. 1 is a side elevation view of a pair of anchors according to the present invention on a conduit passing through a concrete barrier.

FIG. 2 is a top view of an anchor according one or more embodiments to the present invention.

FIG. 3 is top and side perspective partially exploded view of the anchor depicted in FIG. 2.

### DETAILED DESCRIPTION OF THE PREFERRED EMBODIMENTS

With reference the attached drawings, one or more embodiments of the present invention will now be described with the understanding that the described embodiments are merely preferred and are not intended to be limiting.

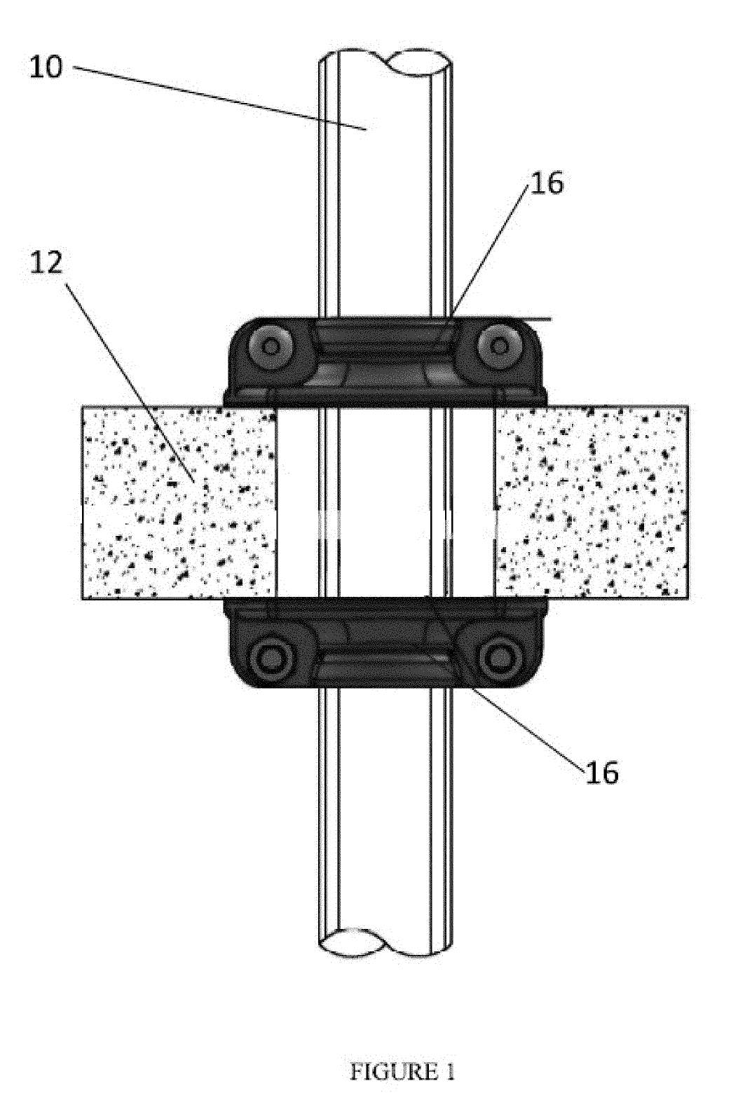

As shown in FIG. 1, the present invention includes, generally, a conduit 10 extending through a barrier 12 (such as floor, like a concrete floor, or ceiling, or wall). According to a preferred embodiment, disposed around the conduit 10 on both sides or surfaces (i.e., upper and lower surfaces) of the barrier 12 are anchors 16. Although two anchors 16 are shown, one above the barrier 12 and one below the barrier 12, it is contemplated that the conduit 10 only includes one anchor 16. When only one anchor 16 is used, the anchor 16 is preferably located on the upper side of the barrier 12 to provide support in an axial direction of the conduit 10, against the force of gravity. However, this is merely preferred.

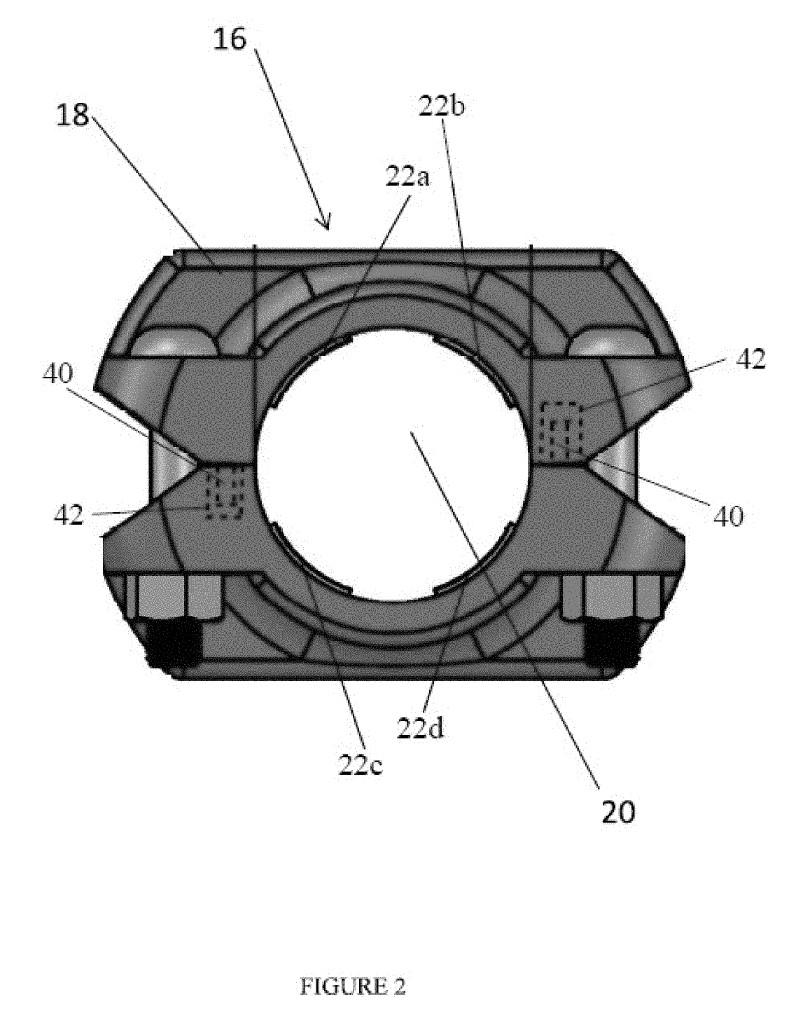

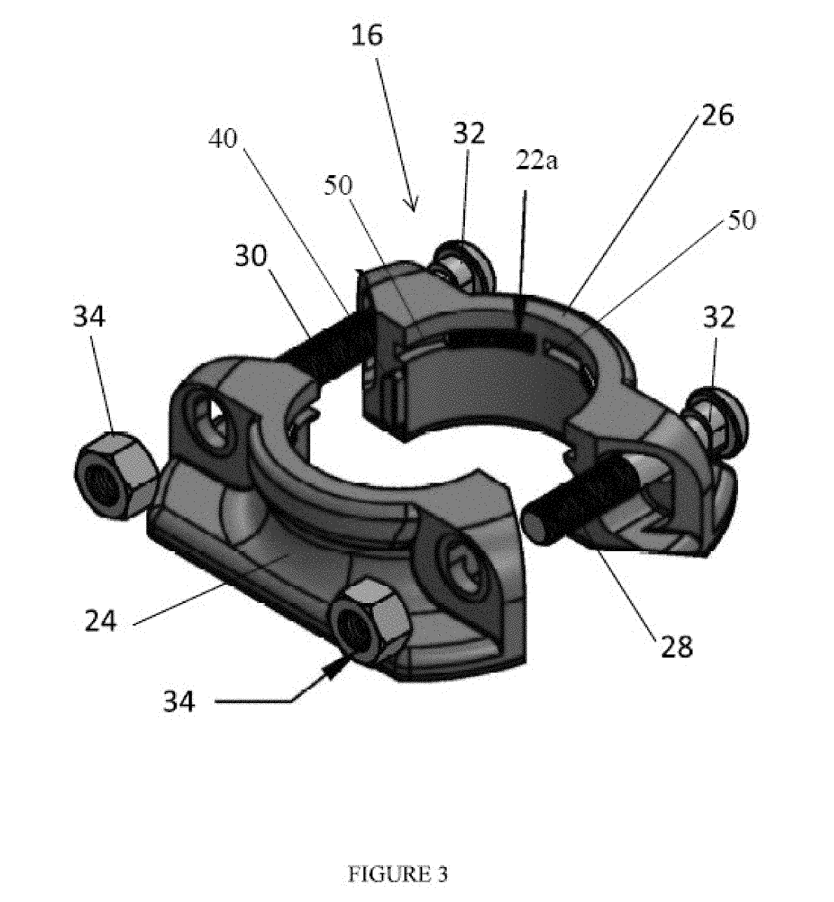

Turning to FIGS. 2 and 3, an anchor 16 according to various embodiments of the present invention includes a body 18 with an aperture 20 extending through the body 18. The body 18 is preferably formed from ductile iron, but other materials may be used. The aperture 20 is sized to receive a conduit with a specific size (or a small range of sizes). The aperture 20 is cylindrically shaped and may have a diameter between 2.5 inches and 8 inches.

Teeth 22a, 22b, 22c, 22d are disposed in the body 18 and extend inwardly into the aperture 20 (towards the center) to provide a clamping force in an inward radial direction relative to an axis of the conduit 10. The teeth 22a, 22b, 22c, 22d each have a curved shaped (when viewed from the top) forming an arc that is concentric with the aperture 20. Preferably, the teeth 22a, 22b, 22c, 22d are equidistantly disposed around the circumference of the aperture 20 relative to each. The depicted anchor 16 of FIGS. 2 and 3 includes four teeth 22a, 22b, 22c, 22d. However, there could be different numbers of teeth 22a, 22b, 22c, 22d, such as two, one on each body member 24, 26 (discussed below), three, one, and two, or more than four, particularly with larger diameter conduits 10.

The teeth 22a, 22b, 22c, 22d are formed from a plurality of alternating, from top to bottom, peaks and valleys extending along the length of the teeth 22a, 22b, 22c, 22d. In other words, in a side view, the teeth 22a, 22b, 22c, 22d have a zigzag contour. The teeth 22a, 22b, 22c, 22d may be case-hardened and electroplated carbon steel. Other materials may be used for the teeth 22a, 22b, 22c, 22d, preferably from a material that is harder or more rigid than the material of the conduit 10.

As seen best in FIG. 3, the body 18 of the anchor 16 is formed from two body members 24, 26. The two body members 24, 26 are secured together to form the body 18 with fasteners 28, 30. The fasteners 28, 30 each include a bolt 32 and a nut 34. The number of body members 24, 26 and fasteners 28, 30 could be different, such as three, four, or more than four may be used, and the number of body members 24, 26 may depend on the size of the conduit 10. The bolts 32 and nuts 34 are preferably electroplated carbon steel.

The two body members 24, 26 include complementary configured engaging structures 40, 42 to ensure proper or desired alignment when the two members 24, 26 are secured together with the fasteners 28, 30. For example, one side of each member 24, 26 may include a tab 40, while the opposite sides of the body members 24, 26 include notches or cavities 42 sized to receive the tabs 40 (see FIG. 2).

When the bolts 32 and nuts are 34 fully tightened, the two body members 24, 26 will remain slightly spaced apart so that the clamping action is made solely by the teeth 22 and engagement of the two body members 24, 26 does not prevent full tightening of the teeth 22 against the conduit 10.

The teeth 22a, 22b, 22c, 22d may be press fit or slidably received in slots 50 in the body members 24, 26 without the need of other structures. As shown in FIG. 3, the slots 50 have a length greater than the teeth 22a, 22b, 22c, 22d. This allows the teeth 22a, 22b, 22c, 22d to be moved and posited independently of each other. Each body member 24, 26 includes two slots 50.

Alternatively, one or more of the teeth 22a, 22b, 22c, 22d may be integrally formed with the body members 24, 26, for example if the conduit 10 is made from a material that is softer than the material of the body members 24, 26.

In use, the body members 24, 26 are positioned around the conduit 10, preferably in a position with a surface of the anchor 16 abutting the barrier 12. The tabs 40 may be aligned with the notches 42 to ensure properly alignment. Each bolt 32 is passed through one of the body members 24, 26 into the other body member 24, 26. The nuts 34 are threaded onto the bolts 32 and tightened to form the body 18 of the anchor 16.

As the nuts 34 (or bolts 32) are further tightened, the teeth 22a, 22b, 22c, 22d will contact the outer surface of the conduit 10 within the aperture 20. As the nuts 34 (or bolts 32) are even further tightened, the teeth 22a, 22b, 22c, 22d engage and grip the conduit 10. The teeth 22, which deform a portion of the outer surface of the conduit 10 because of the purchase of the teeth 22 on the conduit 10, will not pierce or puncture the conduit 10. If the anchor 16 needs to be removed, the nuts 34 (or bolts 32) are loosened, and the teeth 22 will lessen, and eventually lose, their grip on the conduit 10.

As is apparent from the foregoing specification, the invention is susceptible of being embodied with various alterations and modifications which may differ particularly from those that have been described in the preceding specification and description. It should be understood that I wish to embody within the scope of the patent warranted hereon all such modifications as reasonably and properly come within the scope of my contribution to the art.

1. An anchor for a conduit, the conduit extending through a barrier, the anchor comprising:
a body having a plurality of body members, the body members forming an aperture for the conduit;
at least one fastener holding the body members together; and,
teeth extending into the aperture.

2. The anchor of claim 1, wherein the aperture includes an inner surface, the inner surface facing the conduit and wherein the teeth extend inwardly from the inner surface.

3. The anchor of claim 1, wherein the body includes at least one slot, and wherein the teeth are received in the at least one slot.

4. The anchor of claim 1, wherein the teeth have a shape that, when viewed from a top, is concentric with the aperture.

5. The anchor of claim 1, wherein the teeth are formed from a plurality of alternating peaks and valleys.

6. The anchor of claim 1, further comprising a plurality of teeth.

7. The anchor of claim 6 wherein the teeth from the plurality of teeth are disposed equidistantly, relative to each other, around a circumference of the aperture.

8. The anchor of claim 1, wherein the body members include complementarily configured engaging structures configured to ensure alignment of adjacent body members.

9. The anchor of claim 1, wherein the teeth are made from a material that is harder than a material of the conduit.

10. The anchor of claim 1, wherein the body comprises two body members, and wherein each body member includes two slots, and wherein the anchor further comprises:
four pluralities of teeth extending into the aperture, wherein each slot of the body members includes one of the pluralities of teeth.

11. The anchor of claim 1 wherein the teeth are each formed from a plurality of alternating peaks and valleys.

12. An anchor for a conduit, the conduit extending through a barrier, the anchor comprising:
a body having a plurality of body members, the body members forming a cylindrical aperture for the conduit, each body member including a slot; and,
teeth slideably received within each of the slots, wherein the teeth extend inwardly toward a center of the cylindrical aperture.

13. The anchor of claim 12, wherein each of the teeth are movable independent of each other.

14. The anchor of claim 12, wherein the teeth are formed from a plurality of alternating peaks and valleys.

15. The anchor of claim 12 further comprising:
a plurality of teeth, wherein the teeth are disposed equidistantly, relative to each other, around a circumference of the aperture.

16. The anchor of claim 12, wherein the body members include complementarily configured engaging structures configured to ensure alignment of adjacent body members.

17. The anchor of claim 12, wherein the teeth are made from a material that is harder than a material of the conduit.

18. A method of supporting a conduit passing through a barrier, the method comprising:
positioning each of a plurality of body members around the conduit, wherein the conduit passes through the barrier;
tightening at least one fastener to secure together the body members; and,
deforming an outer surface of the conduit by teeth in the body members to engage the conduit.

19. The method of claim 18 wherein the body members are positioned on an upper surface of the barrier, and the method further comprising:
positioning each of a second plurality of body members around the conduit on a lower surface of the barrier;
tightening at least one fastener to secure together the body members from the second plurality of body members; and,
deforming the outer surface of the conduit by teeth in the body members from the plurality of body members.

20. The method of claim 18 further comprising:
slideably inserting the teeth into each of the body members prior to positioning the body members around the conduit.
